(19) United States
(12) Patent Application Publication
(10) Pub. No.: US 2015/0168639 A1
(43) Pub. Date: Jun. 18, 2015

(54) LIGHT-EMITTING DEVICE FOR GENERATING A SPECIFIC LIGHT PATTERN AND LIGHT-GUIDING UNIT THEREOF

(71) Applicant: WEN-SHIN PAN, Taipei City (TW)

(72) Inventor: WEN-SHIN PAN, Taipei City (TW)

(21) Appl. No.: 14/541,207

(22) Filed: Nov. 14, 2014

(30) Foreign Application Priority Data
Nov. 15, 2013 (TW) 102141749

(51) Int. Cl. F21V 8/00

(52) U.S. Cl. CPC G02B 6/0085; G02B 6/0038; G02B 6/0036; G02B 6/0088

(57) ABSTRACT

A light-emitting device for generating a specific light pattern and a light-guiding unit thereof are disclosed. The light-guiding unit includes a light-guiding plate, a reflective layer having a first predetermined reflectance disposed between the light-guiding plate and the bridge support, a patterned light-guiding microstructure with a predetermined pattern having a second predetermined reflectance disposed between the light-guiding plate and the reflective layer, and a light uniform microstructure disposed on the light-guiding plate and correspondingly opposite to the patterned light-guiding microstructure, and the first predetermined reflectance of the reflective layer is different from the second predetermined reflectance of the patterned light-guiding microstructure. Therefore, initial light beams generated by the two light-emitting modules are reflected by the patterned light-guiding microstructure to form a projection light source with the specific light pattern passing through the light uniform microstructure.

### BACKGROUND OF THE INVENTION

1. Field of the Invention

The instant disclosure relates to a light-emitting device and a light-guiding unit thereof, and more particularly to a light-emitting device for generating a specific light pattern and a light-guiding unit thereof.

2. Description of Related Art

The invention of the lamp greatly changed the style of building construction and the lifestyle of human beings, allowing people to work during the night. Traditional lighting devices such as lamps that adopt incandescent bulbs, fluorescent bulbs, or power-saving bulbs have been generally well-developed and used intensively for indoor illumination.

Moreover, compared to the newly developed light-emitting-diode (LED) lamps, these traditional lamps have the disadvantages of quick attenuation, high power consumption, high heat generation, short service life, high fragility, and being not recyclable. Thus, various high-powered LED lamps are created to replace the traditional lighting devices. Among them, tubular LED lamps are gaining popularity for their dimensional resemblance of traditional fluorescent tubes and thus their adoptability to existing lighting devices.

### SUMMARY OF THE INVENTION

One aspect of the instant disclosure relates to a light-emitting device for generating a specific light pattern and a light-guiding unit thereof.

One of the embodiments of the instant disclosure provides a light-emitting device for generating a specific light pattern, comprising: a heat-dissipating unit, a light-emitting unit, a support unit, and a light-guiding unit. The heat-dissipating unit includes two heat-dissipating structures separated from each other by a predetermined distance. The light-emitting unit includes two light-emitting modules respectively detachably disposed on the two heat-dissipating structures. The support unit includes a bridge support detachably disposed between the two heat-dissipating structures, and the bridge support has a retaining groove disposed on a bottom side thereof. The light-guiding unit is detachably disposed inside the retaining groove of the bridge support. The light-guiding unit includes a light-guiding plate, a reflective layer having a first predetermined reflectance disposed between the light-guiding plate and the bridge support, a patterned light-guiding microstructure with a predetermined pattern having a second predetermined reflectance disposed between the light-guiding plate and the reflective layer, and a light uniform microstructure disposed on the light-guiding plate and correspondingly opposite to the patterned light-guiding microstructure, and the first predetermined reflectance of the reflective layer is different from the second predetermined reflectance of the patterned light-guiding microstructure. Therefore, initial light beams generated by the two light-emitting modules are reflected by the patterned light-guiding microstructure to form a projection light source with the specific light pattern passing through the light uniform microstructure.

More precisely, each heat-dissipating structure includes a top heat-dissipating unit, a bottom heat-dissipating unit opposite to the top heat-dissipating unit, an outside heat-dissipating unit connected between the top heat-dissipating unit and the bottom heat-dissipating unit, and an inside heat-dissipating unit opposite to the outside heat-dissipating unit, wherein the top heat-dissipating unit has a plurality of top heat-dissipating fins extended upwardly from the heat-dissipating structure, the bottom heat-dissipating unit has a plurality of bottom heat-dissipating fins extended downwardly from the heat-dissipating structure, the outside heat-dissipating unit has a plurality of outside heat-dissipating fins extended outwardly from the heat-dissipating structure, and the inside heat-dissipating unit has a plurality of inside heat-dissipating fins extended inwardly from the heat-dissipating structure.

More precisely, each heat-dissipating structure has a receiving space among the top heat-dissipating unit, the bottom heat-dissipating unit, the outside heat-dissipating unit, and the inside heat-dissipating unit, and each light-emitting module includes a circuit substrate detachably disposed inside the receiving space to directly contact the corresponding heat-dissipating structure and a plurality of light-emitting diodes disposed on the circuit substrate and electrically connected to the circuit substrate.

More precisely, the light-emitting device further comprises a light-shading unit including two light-shading covers respectively disposed on the two heat-dissipating structures to respectively cover the two light-emitting modules, wherein each circuit substrate is positioned on the corresponding heat-dissipating structure through a plurality of first securing members, two opposite end portions of the bridge support are respectively positioned on the two heat-dissipating structures through a plurality of second securing members, and each light-shading cover is positioned on the corresponding heat-dissipating structure through a plurality of third securing members to cover the light-emitting diodes of the corresponding light-emitting module.

More precisely, the light-guiding plate has two light input surfaces respectively facing the two light-emitting modules, a reflective surface connected between the two light input surfaces and facing the bridge support, and a light output surface opposite to the reflective surface, and the patterned light-guiding microstructure has a plurality of microgrooves parallel to the two light input surfaces or a plurality of quadrangular pyramids arranged as a matrix, wherein the bridge support has two hook portions respectively extended downwardly from two opposite long lateral sides thereof, and two opposite long lateral sides of the light-guiding unit are respectively retained inside the two hook portions of the bridge support.

More precisely, the patterned light-guiding microstructure with the predetermined pattern is integrally disposed on the reflective surface of the light-guiding plate, the reflective layer is attached to the reflective surface to cover the patterned light-guiding microstructure, and the light uniform microstructure is disposed on the light output surface of the light-guiding plate.

More precisely, the patterned light-guiding microstructure with the predetermined pattern is prefabricated on an inner surface of the reflective layer, the reflective layer is attached to the reflective surface to cover the patterned light-guiding microstructure, and the light uniform microstructure is disposed on the light output surface of the light-guiding plate.

Another one of the embodiments of the instant disclosure provides a light-guiding unit for generating a specific light pattern, comprising: a heat-dissipating unit, a light-emitting unit, a support unit, and a light-guiding unit. The light-guiding plate has two light input surfaces respectively facing two light-emitting modules, a reflective surface connected between the two light input surfaces, and a light output surface opposite to the reflective surface. The reflective layer is disposed on the reflective surface of the light-guiding plate, wherein the reflective layer has a first predetermined reflectance. The patterned light-guiding microstructure with a predetermined pattern is disposed between the reflective surface of the light-guiding plate and the reflective layer. The patterned light-guiding microstructure has a second predetermined reflectance, and the first predetermined reflectance of the reflective layer is different from the second predetermined reflectance of the patterned light-guiding microstructure. The light uniform microstructure is disposed on the light output surface of the light-guiding plate, and the light uniform microstructure is correspondingly opposite to the patterned light-guiding microstructure. Therefore, initial light beams generated by the two light-emitting modules are reflected by the patterned light-guiding microstructure to form a projection light source with the specific light pattern passing through the light uniform microstructure.

Yet another one of the embodiments of the instant disclosure provides a light-emitting device for generating a specific light pattern, comprising: a heat-dissipating unit, a light-emitting unit, a support unit, and a light-guiding unit. The heat-dissipating unit includes at least one heat-dissipating structure. The light-emitting unit includes at least one light-emitting module detachably disposed on the at least one heat-dissipating structure. The support unit includes a bridge support detachably disposed on the at least one heat-dissipating structure, and the bridge support has a retaining groove. The light-guiding unit is detachably disposed inside the retaining groove of the bridge support. The light-guiding unit includes a light-guiding plate, a reflective layer having a first predetermined reflectance disposed between the light-guiding plate and the bridge support, a patterned light-guiding microstructure with a predetermined pattern having a second predetermined reflectance disposed between the light-guiding plate and the reflective layer, and a light uniform microstructure disposed on the light-guiding plate and correspondingly opposite to the patterned light-guiding microstructure, and the first predetermined reflectance of the reflective layer is different from the second predetermined reflectance of the patterned light-guiding microstructure. Therefore, initial light beams generated by the at least one light-emitting module are reflected by the patterned light-guiding microstructure to form a projection light source with the specific light pattern passing through the light uniform microstructure.

More precisely, the light-emitting device further comprises a light-shading unit including at least one light-shading cover disposed on the at least one heat-dissipating structure to cover the at least one light-emitting module.

More precisely, the light-guiding plate includes a light-guiding body, a plurality of reflective microparticles disposed inside the light-guiding body, and a plurality of carrier substances disposed inside the light-guiding body to carry the reflective microparticles to be uniformly diffused inside the light-guiding body.

More precisely, the refractive of the light-guiding body is different from the index refractive index of the reflective microparticle.

More precisely, the viscosity of the carrier substance is smaller than the viscosity of the light-guiding body.

More precisely, the specific light pattern of the projection light source is adjustable according to the number of the reflective microparticles.

More precisely, the flowability of the reflective microparticles inside the light-guiding body is increased through the carrier substances.

Therefore, the initial light beams generated by the light-emitting module can be reflected by the patterned light-guiding microstructure to form a projection light source with the specific light pattern due to the design of “a reflective layer having a first predetermined reflectance disposed between the light-guiding plate and the bridge support” and “a patterned light-guiding microstructure with a predetermined pattern having a second predetermined reflectance disposed between the light-guiding plate and the reflective layer”. Thus, the instant disclosure can change the predetermined pattern of the patterned light-guiding microstructure to obtain different light pattern of the projection light source generated by the light-emitting device.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows a first partial, exploded, schematic view of a light-emitting device for generating a specific light pattern according to the instant disclosure;

FIG. 1B shows a second partial, exploded, schematic view of a light-emitting device for generating a specific light pattern according to the instant disclosure;

FIG. 2A shows another first partial, exploded, schematic view of a light-emitting device for generating a specific light pattern according to the instant disclosure;

FIG. 2B shows another second partial, exploded, schematic view of a light-emitting device for generating a specific light pattern according to the instant disclosure;

FIG. 3 shows a perspective, assembled, schematic view of a light-emitting device for generating a specific light pattern according to the instant disclosure;

FIG. 4 shows another perspective, assembled, schematic view of a light-emitting device for generating a specific light pattern according to the instant disclosure;

FIG. 5 shows a cross-sectional view taken along the section line A-A of FIG. 3;

FIG. 6 shows a lateral, schematic view of a light-guiding unit according to the instant disclosure;

FIG. 7 shows a lateral, schematic view of another light-guiding unit according to the instant disclosure;

FIG. 8 shows a top, schematic view of a patterned light-guiding microstructure having a predetermined pattern according to the instant disclosure;

FIG. 9 shows a top, schematic view of another patterned light-guiding microstructure having another predetermined pattern according to the instant disclosure;

FIG. 10 shows a perspective, schematic view of at least one light-emitting device applied to an illumination device according to the instant disclosure; and

FIG. 11 shows a perspective, schematic view of many light-emitting devices applied to an illumination device according to the instant disclosure.

### DETAILED DESCRIPTION OF THE PREFERRED EMBODIMENTS

The embodiments of “a light-emitting device for generating a specific light pattern and a light-guiding unit thereof” of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

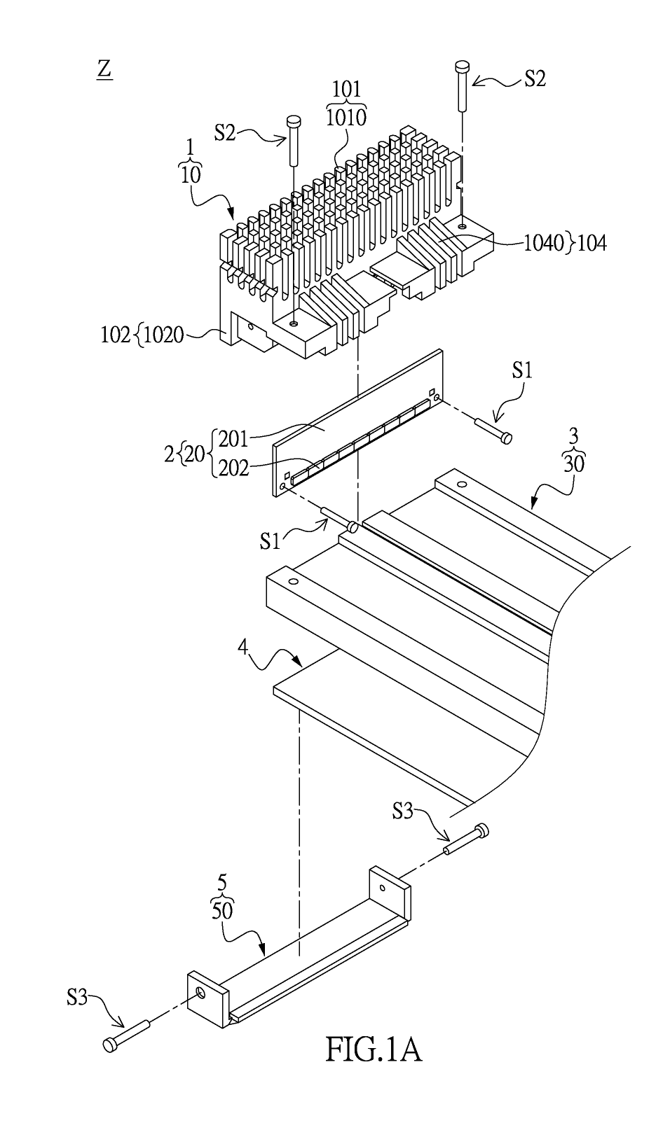

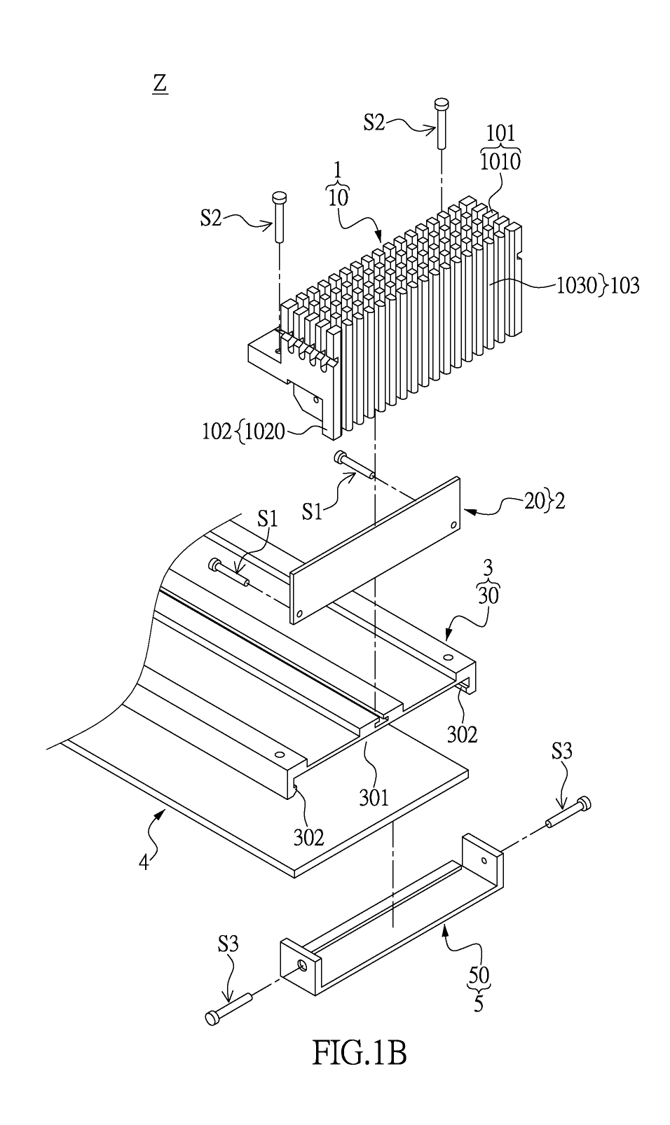

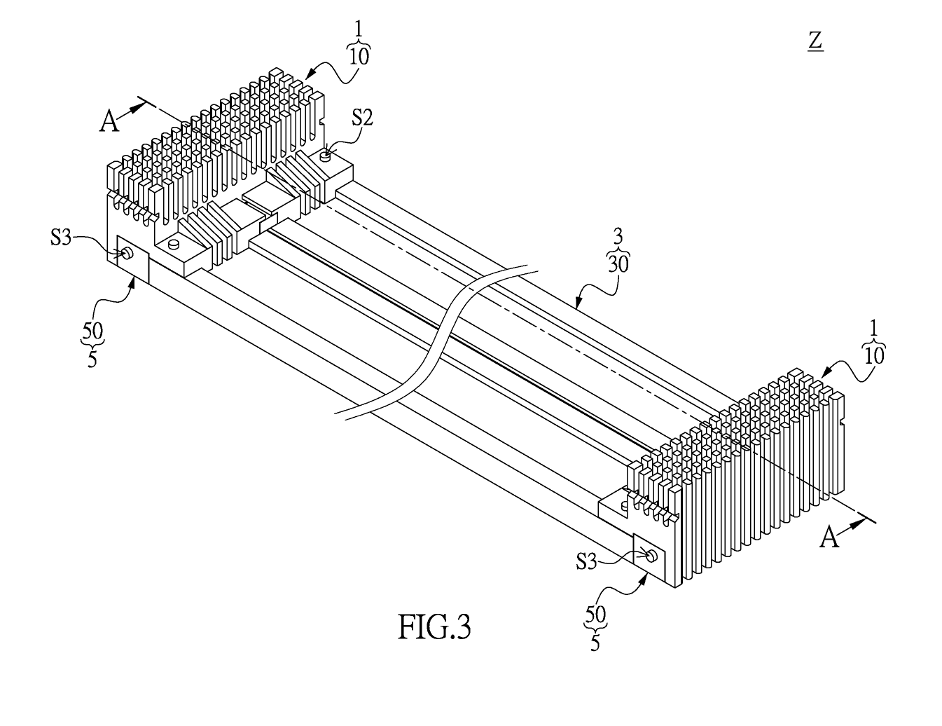

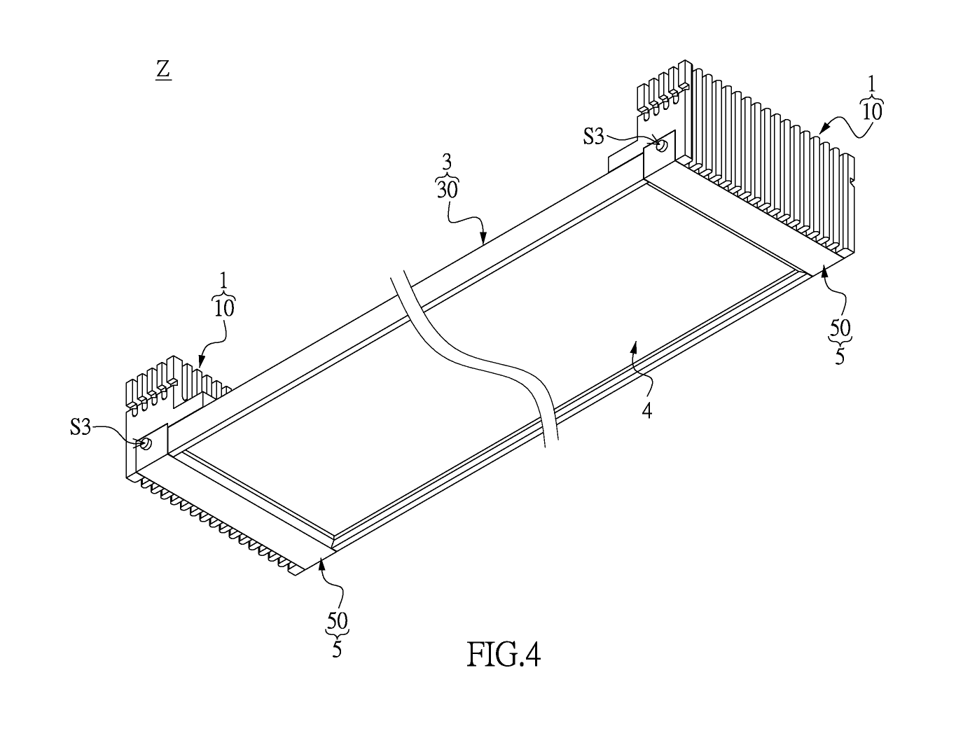

Referring to FIG. 1A to FIG. 9, the instant disclosure provides a light-emitting device Z for generating a specific light pattern, comprising: a heat-dissipating unit 1, a light-emitting unit 2, a support unit 3, and a light-guiding unit 4. The light-emitting device Z can be used as an illumination device such as fluorescent lamp disposed on the ceiling.

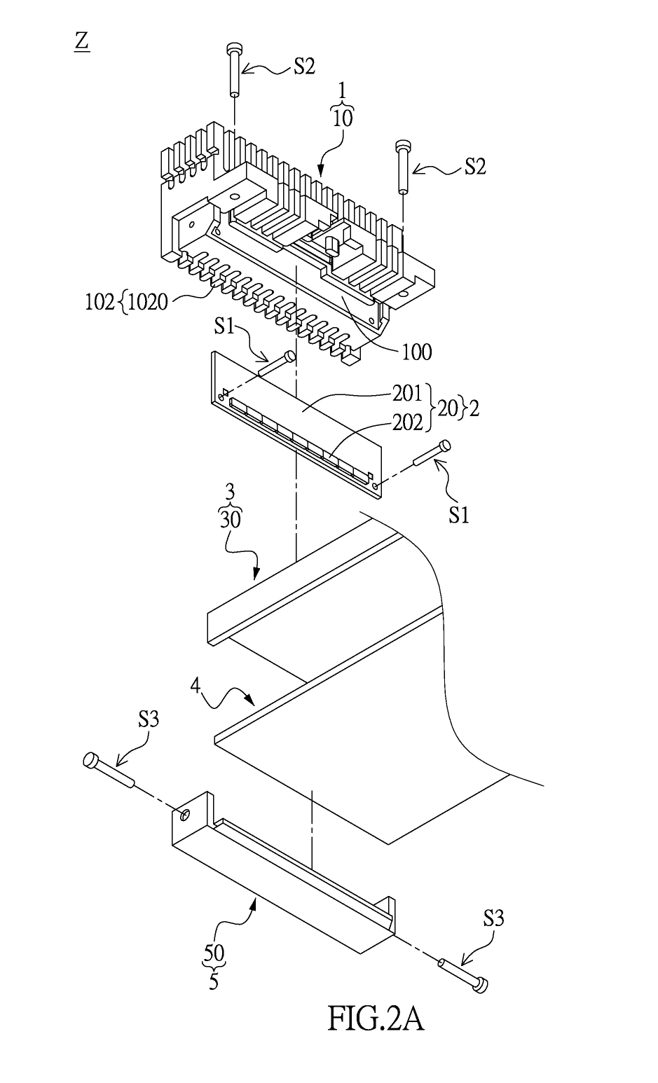

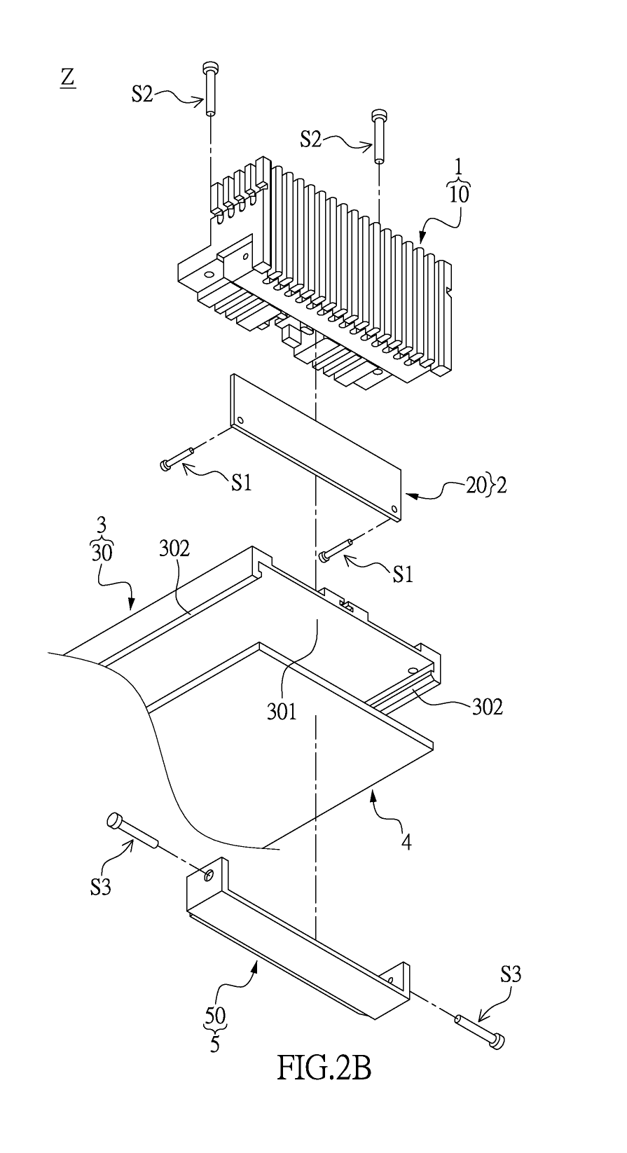

First, referring to FIG. 1A and FIG. 2B, the heat-dissipating unit 1 includes two heat-dissipating structures 10 separated from each other by a predetermined distance. More precisely, each heat-dissipating structure 10 includes a top heat-dissipating unit 101, a bottom heat-dissipating unit 102 opposite to the top heat-dissipating unit 101, an outside heat-dissipating unit 103 connected between the top heat-dissipating unit 101 and the bottom heat-dissipating unit 102, and an inside heat-dissipating unit 104 opposite to the outside heat-dissipating unit 103. In addition, the top heat-dissipating unit 101 has a plurality of top heat-dissipating fins 1010 extended upwardly from the heat-dissipating structure 10, the bottom heat-dissipating unit 102 has a plurality of bottom heat-dissipating fins 1020 extended downwardly from the heat-dissipating structure 10, the outside heat-dissipating unit 103 has a plurality of outside heat-dissipating fins 1030 extended outwardly from the heat-dissipating structure 10, and the inside heat-dissipating unit 104 has a plurality of inside heat-dissipating fins 1040 extended inwardly from the heat-dissipating structure 10. However, the aforementioned design for the heat-dissipating unit 1 is merely an example and is not meant to limit the instant disclosure.

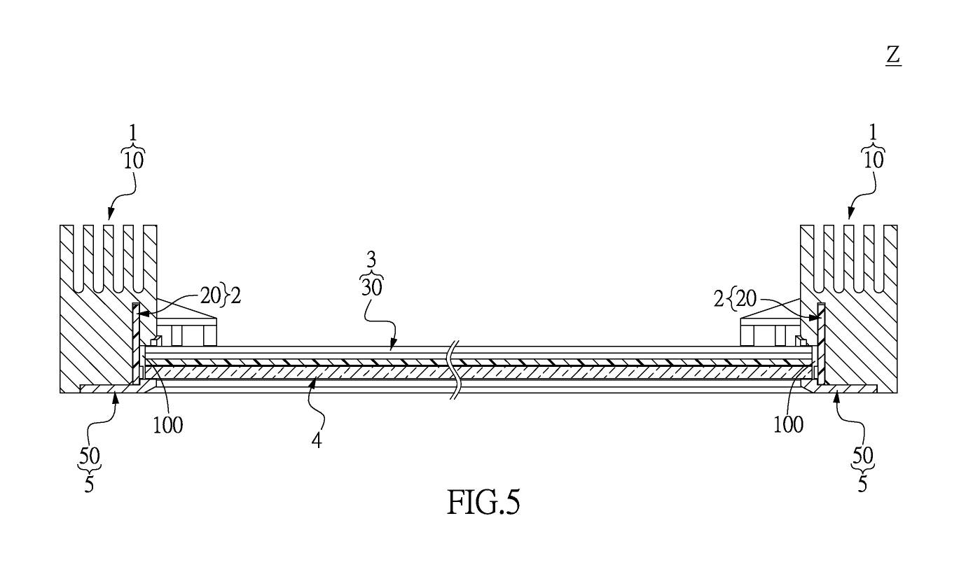

Moreover, referring to FIG. 1A to FIG. 2B, and FIG. 5, the light-emitting unit 2 includes two light-emitting modules 20 respectively detachably disposed on the two heat-dissipating structures 10. More precisely, each heat-dissipating structure 10 has a receiving space 100 among the top heat-dissipating unit 101, the bottom heat-dissipating unit 102, the outside heat-dissipating unit 103, and the inside heat-dissipating unit 104, and each light-emitting module 20 includes a circuit substrate 201 detachably disposed inside the receiving space 100 to directly contact the corresponding heat-dissipating structure 10 and a plurality of light-emitting diodes 202 disposed on the circuit substrate 201 and electrically connected to the circuit substrate 201. For example, each circuit substrate 201 is positioned on the corresponding heat-dissipating structure 10 through a plurality of first securing members S1 such as bolts or screws.

Furthermore, referring to FIG. 1A to FIG. 5, the support unit 3 includes a bridge support 30 such as a holder detachably disposed between the two heat-dissipating structures 10. The bridge support 30 has a retaining groove 301 disposed on a bottom side thereof, and a transformer (not shown) electrically connected to the light-emitting module 20 may be placed on the top side of the bridge support 30. More precisely, two opposite end portions of the bridge support 30 are respectively positioned on the two heat-dissipating structures 10 through a plurality of second securing members S2 (such as bolts or screws). The bridge support 30 has two hook portions 302 respectively extended downwardly from two opposite long lateral sides thereof, such that two opposite long lateral sides of the light-guiding unit 4 are respectively retained inside the two hook portions 302 of the bridge support 30. For example, the bridge support 30 may be made of any opaque material, but this is merely an example and is not meant to limit the instant disclosure. It is worth mentioning that the two heat-dissipating structures 10 of the heat-dissipating unit 1 and the bridge support 30 of the support unit 3 can be integrally formed as a single component.

In addition, referring to FIG. 1A to FIG. 2B, the light-guiding unit 4 is detachably disposed inside the retaining groove 301 of the bridge support 30. The light-guiding unit 4 includes a light-guiding plate 40, a reflective layer 41 having a first predetermined reflectance disposed between the light-guiding plate 40 and the bridge support 30, a patterned light-guiding microstructure 42 with a predetermined pattern having a second predetermined reflectance disposed between the light-guiding plate 40 and the reflective layer 41, and a light uniform microstructure 43 disposed on the light-guiding plate 40 and correspondingly opposite to the patterned light-guiding microstructure 42, and the first predetermined reflectance of the reflective layer 41 is different from the second predetermined reflectance of the patterned light-guiding microstructure 42.

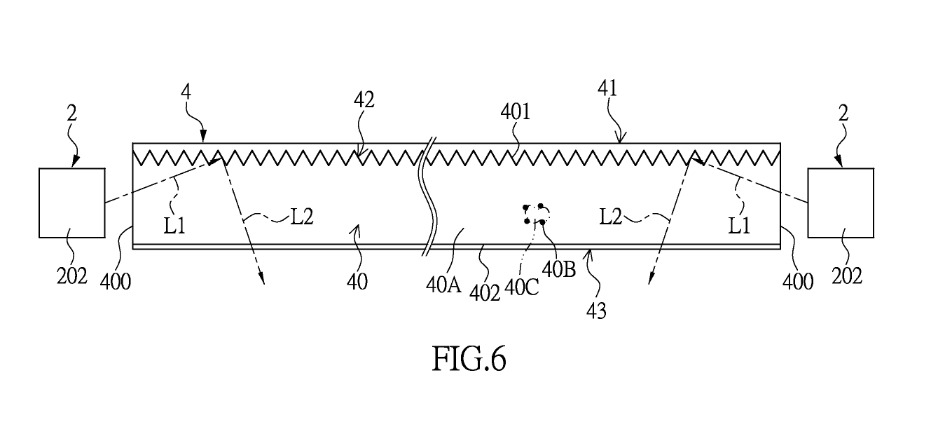

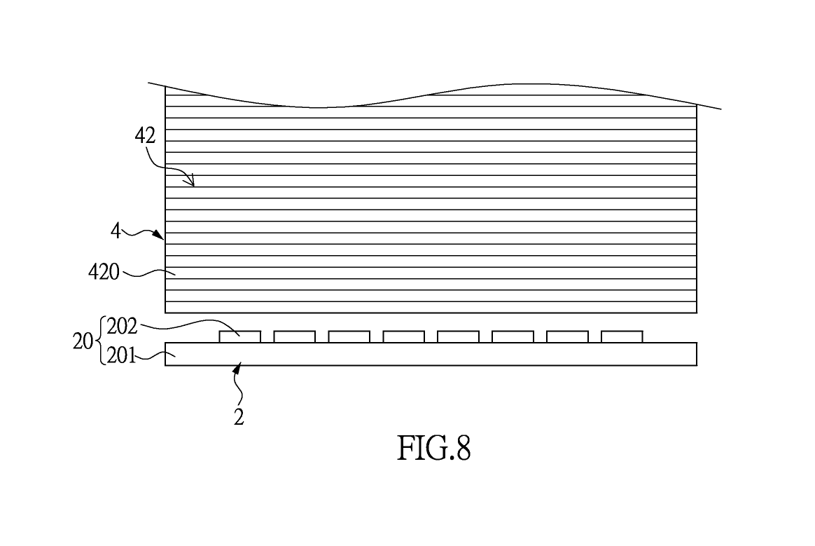

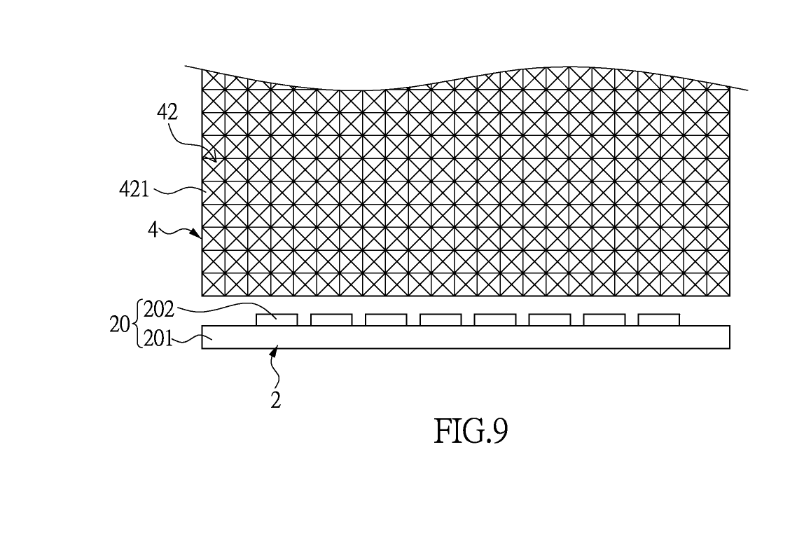

More precisely, referring to FIG. 5 and FIG. 6, the light-guiding plate 40 has two light input surfaces 400 respectively facing the two light-emitting modules 20, a reflective surface 401 connected between the two light input surfaces 400 and facing the bridge support 30, and a light output surface 402 opposite to the reflective surface 401. For example, as shown in FIG. 6, the patterned light-guiding microstructure 42 with the predetermined pattern may be integrally disposed on the reflective surface 401 of the light-guiding plate 40, the reflective layer 41 can be attached to the reflective surface 401 to cover the patterned light-guiding microstructure 42, and the light uniform microstructure 43 can be disposed on the light output surface 402 of the light-guiding plate 40 by screen printing. In addition, the patterned light-guiding microstructure 42 may be composed of many microgrooves 420 or quadrangular pyramids 421 according to different requirements. For example, the patterned light-guiding microstructure 42 has a plurality of microgrooves 420 parallel to the two light input surfaces 400 as shown in FIG. 8. Alternatively, the patterned light-guiding microstructure 42 has a plurality of quadrangular pyramids 421 arranged as a matrix as shown in FIG. 9.

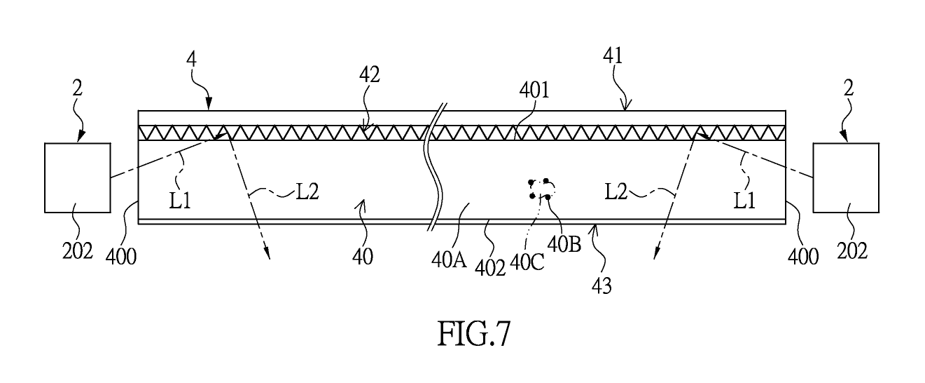

Of course, as shown in FIG. 7, the patterned light-guiding microstructure 42 with the predetermined pattern also can be prefabricated on an inner surface of the reflective layer 41 (that is to say, the patterned light-guiding microstructure 42 may be formed on the inner surface of the reflective layer 41 by printing or coating in advance), and then the reflective layer 41 is attached to the reflective surface 401 to cover the patterned light-guiding microstructure 42. In other words, the patterned light-guiding microstructure 42 with the predetermined pattern may be integrally disposed or prefabricated on the reflective surface 401 of the light-guiding plate 40 according to different requirements.

Referring to FIG. 6 or FIG. 7, it is worth mentioning that the light-guiding plate 40 includes a light-guiding body 40A, a plurality of reflective microparticles 40B disposed inside the light-guiding body 40A, and a plurality of carrier substances 40C disposed inside the light-guiding body 40A to carry the reflective microparticles 40B to be uniformly diffused inside the light-guiding body 40A. More precisely, the refractive of the light-guiding body 40A is different from the index refractive index of the reflective microparticle 40B, and the viscosity of the carrier substance 40C is smaller than the viscosity of the light-guiding body 40A. It is worth mentioning that the specific light pattern of the projection light source L2 generated by the light-emitting device Z can be adjustable or changeable according to the number of the reflective microparticles 40B. When the reflective microparticles 40B and the carrier substances 40C are mixed inside the light-guiding body 40A, the carrier substances 40C can be used to carry the reflective microparticles 40B for increasing the flowability of the reflective microparticles 40B inside the light-guiding body 40A. For example, the light-guiding body 40A may be made of any light-transmitting plastic material such as polymethylmethacrylate (PMMA), and the carrier substances 40C may be made of any light-transmitting organic or inorganic material such as a salad oil or a soybean oil. However, that is merely an example and is not meant to limit the instant disclosure.

Moreover, the light-emitting device Z further comprises a light-shading unit 5 including two light-shading covers 50 respectively disposed on the two heat-dissipating structures 10 to respectively partially cover the two light-emitting modules 20. For example, each light-shading cover 50 is positioned on the corresponding heat-dissipating structure 10 through a plurality of third securing members S3 to cover the light-emitting diodes 202 of the corresponding light-emitting module 20.

Therefore, initial light beams L1 generated by the light-emitting diodes 202 of the two light-emitting modules 20 are reflected by the patterned light-guiding microstructure 42 (or by matching the reflective layer 41 and the patterned light-guiding microstructure 42) to form a projection light source L2 with the specific light pattern passing through the light uniform microstructure 43. Thus, the instant disclosure can change the predetermined pattern of the patterned light-guiding microstructure 42 to obtain different light pattern of the projection light source L2 generated by the light-emitting device Z.

More precisely, another embodiment of the instant disclosure provides a light-emitting device Z for generating a specific light pattern, comprising: a light-dissipating unit 1, a light-emitting unit 2, a support unit 3, and a light-guiding unit 4. The heat-dissipating unit 1 includes at least one heat-dissipating structure 10 (without using another heat-dissipating structure 10). The light-emitting unit 2 includes at least one light-emitting module 20 (without using another light-emitting module 20) detachably disposed on the at least one heat-dissipating structure 10. The support unit 3 includes a bridge support 30 detachably disposed on the at least one heat-dissipating structure 10, and the bridge support 30 has a retaining groove 301. The light-guiding unit 4 is detachably disposed inside the retaining groove 301 of the bridge support 30. The light-guiding unit 4 includes a light-guiding plate 40, a reflective layer 41 having a first predetermined reflectance disposed between the light-guiding plate 40 and the bridge support 30, a patterned light-guiding microstructure 42 with a predetermined pattern having a second predetermined reflectance disposed between the light-guiding plate 40 and the reflective layer 41, and a light uniform microstructure 43 disposed on the light-guiding plate 40 and correspondingly opposite to the patterned light-guiding microstructure 42, and the first predetermined reflectance of the reflective layer 41 is different from the second predetermined reflectance of the patterned light-guiding microstructure 42.

Moreover, the light-emitting device Z further comprises a light-shading unit 5 including at least one light-shading cover 50 (without using another light-shading cover 50) disposed on the at least one heat-dissipating structure 10 to partially cover the at least one light-emitting module 20. For example, the at least one light-shading cover 50 is positioned on the at least one heat-dissipating structure 10 through a plurality of third securing members S3 to cover the light-emitting diodes 202 of the at least one light-emitting module 20.

Therefore, initial light beams L1 generated by the light-emitting diodes 202 of the at least one light-emitting module 20 are reflected by the patterned light-guiding microstructure 42 (or by matching the reflective layer 41 and the patterned light-guiding microstructure 42) to form a projection light source L2 with the specific light pattern passing through the light uniform microstructure 43. Thus, another embodiment of the instant disclosure can change the predetermined pattern of the patterned light-guiding microstructure 42 to obtain different light pattern of the projection light source L2 generated by the light-emitting device Z.

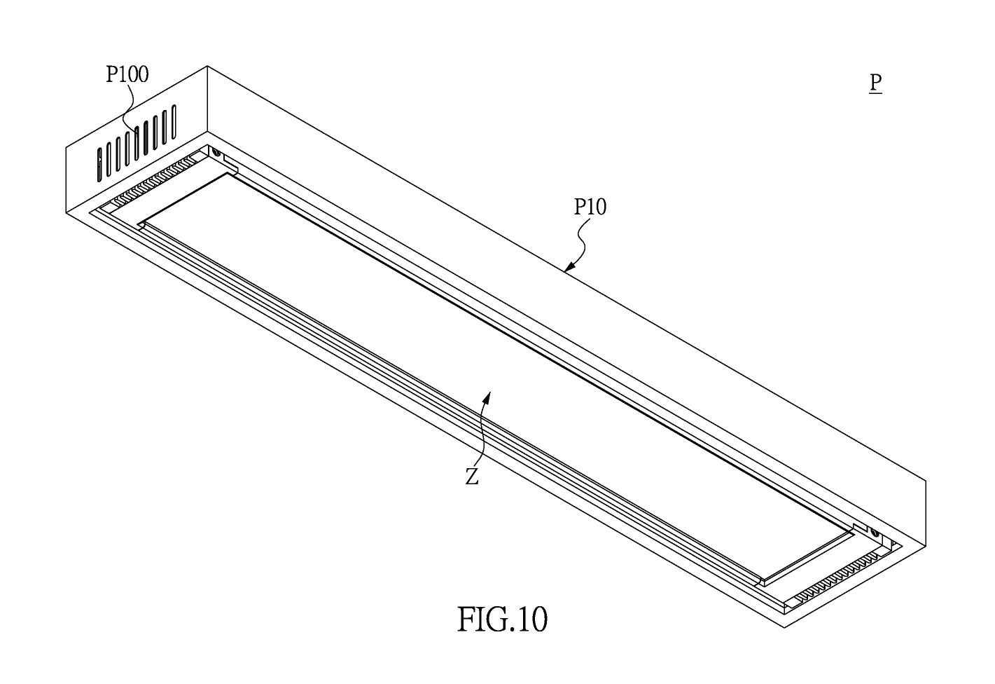

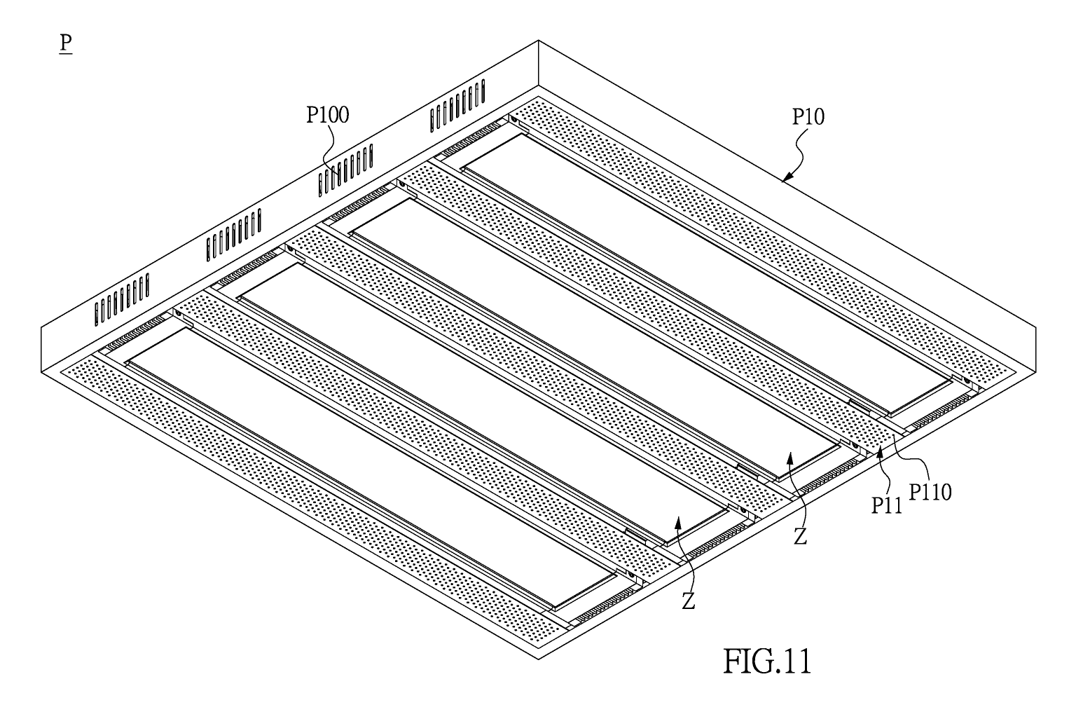

Referring to FIG. 10, it is worth noting that when at least one light-emitting device Z is applied to an illumination device P, the at least one light-emitting device Z can be received in a lampshade P10 having a plurality of heat-dissipating holes P100, such that it is easy for a user to use the modular illumination device P that is composed of the at least one light-emitting device Z and the lampshade P10. For example, the modular illumination device P using the at least one light-emitting device Z can be assembled on the ceiling. Moreover, referring to FIG. 11, when a plurality of light-emitting devices Z are applied to an illumination device P, the light-emitting devices Z can be received in a lampshade P10 having a plurality of heat-dissipating holes P100, such that it is easy for a user to use the modular illumination device P that is composed of the light-emitting devices Z and the lampshade P10. For example, the modular illumination device P using the light-emitting devices Z can be assembled on the ceiling. More precisely, as shown in FIG. 11, each light-emitting device Z is disposed between two heat-dissipating sheets P11 that each has a plurality of heat-dissipating holes P110 for increasing the heat-dissipating efficiency.

In conclusion, the initial light beams L1 generated by the light-emitting module 20 can be reflected by the patterned light-guiding microstructure 42 to form a projection light source L2 with the specific light pattern due to the design of “a reflective layer 41 having a first predetermined reflectance disposed between the light-guiding plate 40 and the bridge support 30” and “a patterned light-guiding microstructure 42 with a predetermined pattern having a second predetermined reflectance disposed between the light-guiding plate 40 and the reflective layer 41”. Thus, the instant disclosure can change the predetermined pattern of the patterned light-guiding microstructure 42 to obtain different light pattern of the projection light source L2 generated by the light-emitting device Z.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A light-emitting device for generating a specific light pattern, comprising:
a heat-dissipating unit including two heat-dissipating structures separated from each other by a predetermined distance;
a light-emitting unit including two light-emitting modules respectively detachably disposed on the two heat-dissipating structures;
a support unit including a bridge support detachably disposed between the two heat-dissipating structures, wherein the bridge support has a retaining groove disposed on a bottom side thereof; and
a light-guiding unit detachably disposed inside the retaining groove of the bridge support, wherein the light-guiding unit includes a light-guiding plate, a reflective layer having a first predetermined reflectance disposed between the light-guiding plate and the bridge support, a patterned light-guiding microstructure with a predetermined pattern having a second predetermined reflectance disposed between the light-guiding plate and the reflective layer, and a light uniform microstructure disposed on the light-guiding plate and correspondingly opposite to the patterned light-guiding microstructure, and the first predetermined reflectance of the reflective layer is different from the second predetermined reflectance of the patterned light-guiding microstructure;
wherein initial light beams generated by the two light-emitting modules are reflected by the patterned light-guiding microstructure to form a projection light source with the specific light pattern passing through the light uniform microstructure.

2. The light-emitting device of claim 1, wherein each heat-dissipating structure includes a top heat-dissipating unit, a bottom heat-dissipating unit opposite to the top heat-dissipating unit, an outside heat-dissipating unit connected between the top heat-dissipating unit and the bottom heat-dissipating unit, and an inside heat-dissipating unit opposite to the outside heat-dissipating unit, wherein the top heat-dissipating unit has a plurality of top heat-dissipating fins extended upwardly from the heat-dissipating structure, the bottom heat-dissipating unit has a plurality of bottom heat-dissipating fins extended downwardly from the heat-dissipating structure, the outside heat-dissipating unit has a plurality of outside heat-dissipating fins extended outwardly from the heat-dissipating structure, and the inside heat-dissipating unit has a plurality of inside heat-dissipating fins extended inwardly from the heat-dissipating structure.

3. The light-emitting device of claim 2, wherein each heat-dissipating structure has a receiving space among the top heat-dissipating unit, the bottom heat-dissipating unit, the outside heat-dissipating unit, and the inside heat-dissipating unit, and each light-emitting module includes a circuit substrate detachably disposed inside the receiving space to directly contact the corresponding heat-dissipating structure and a plurality of light-emitting diodes disposed on the circuit substrate and electrically connected to the circuit substrate.

4. The light-emitting device of claim 3, further comprising: a light-shading unit including two light-shading covers respectively disposed on the two heat-dissipating structures to respectively cover the two light-emitting modules, wherein each circuit substrate is positioned on the corresponding heat-dissipating structure through a plurality of first securing members, two opposite end portions of the bridge support are respectively positioned on the two heat-dissipating structures through a plurality of second securing members, and each light-shading cover is positioned on the corresponding heat-dissipating structure through a plurality of third securing members to cover the light-emitting diodes of the corresponding light-emitting module.

5. The light-emitting device of claim 1, wherein the light-guiding plate has two light input surfaces respectively facing the two light-emitting modules, a reflective surface connected between the two light input surfaces and facing the bridge support, and a light output surface opposite to the reflective surface, and the patterned light-guiding microstructure has a plurality of microgrooves parallel to the two light input surfaces or a plurality of quadrangular pyramids arranged as a matrix, wherein the bridge support has two hook portions respectively extended downwardly from two opposite long lateral sides thereof, and two opposite long lateral sides of the light-guiding unit are respectively retained inside the two hook portions of the bridge support.

6. The light-emitting device of claim 5, wherein the patterned light-guiding microstructure with the predetermined pattern is integrally disposed on the reflective surface of the light-guiding plate, the reflective layer is attached to the reflective surface to cover the patterned light-guiding microstructure, and the light uniform microstructure is disposed on the light output surface of the light-guiding plate.

7. The light-emitting device of claim 5, wherein the patterned light-guiding microstructure with the predetermined pattern is prefabricated on an inner surface of the reflective layer, the reflective layer is attached to the reflective surface to cover the patterned light-guiding microstructure, and the light uniform microstructure is disposed on the light output surface of the light-guiding plate.

8. A light-guiding unit for generating a specific light pattern, comprising:
a light-guiding plate having two light input surfaces respectively facing two light-emitting modules, a reflective surface connected between the two light input surfaces, and a light output surface opposite to the reflective surface;
a reflective layer disposed on the reflective surface of the light-guiding plate, wherein the reflective layer has a first predetermined reflectance;
a patterned light-guiding microstructure with a predetermined pattern disposed between the reflective surface of the light-guiding plate and the reflective layer, wherein the patterned light-guiding microstructure has a second predetermined reflectance, and the first predetermined reflectance of the reflective layer is different from the second predetermined reflectance of the patterned light-guiding microstructure; and
a light uniform microstructure disposed on the light output surface of the light-guiding plate, wherein the light uniform microstructure is correspondingly opposite to the patterned light-guiding microstructure;
wherein initial light beams generated by the two light-emitting modules are reflected by the patterned light-guiding microstructure to form a projection light source with the specific light pattern passing through the light uniform microstructure, and the specific light pattern of the projection light source is adjustable according to the number of the reflective microparticles.

9. The light-guiding unit of claim 8, wherein the patterned light-guiding microstructure has a plurality of microgrooves parallel to the two light input surfaces or a plurality of quadrangular pyramids arranged as a matrix.

10. The light-guiding unit of claim 9, wherein the patterned light-guiding microstructure with the predetermined pattern is integrally disposed on the reflective surface of the light-guiding plate, and the reflective layer is attached to the reflective surface to cover the patterned light-guiding microstructure.

11. The light-guiding unit of claim 9, wherein the patterned light-guiding microstructure with the predetermined pattern is prefabricated on an inner surface of the reflective layer, and the reflective layer is attached to the reflective surface to cover the patterned light-guiding microstructure.

12. A light-emitting device for generating a specific light pattern, comprising:
a heat-dissipating unit including at least one heat-dissipating structure;
a light-emitting unit including at least one light-emitting module detachably disposed on the at least one heat-dissipating structure;
a support unit including a bridge support detachably disposed on the at least one heat-dissipating structure, wherein the bridge support has a retaining groove; and
a light-guiding unit detachably disposed inside the retaining groove of the bridge support, wherein the light-guiding unit includes a light-guiding plate, a reflective layer having a first predetermined reflectance disposed between the light-guiding plate and the bridge support, a patterned light-guiding microstructure with a predetermined pattern having a second predetermined reflectance disposed between the light-guiding plate and the reflective layer, and a light uniform microstructure disposed on the light-guiding plate and correspondingly opposite to the patterned light-guiding microstructure, and the first predetermined reflectance of the reflective layer is different from the second predetermined reflectance of the patterned light-guiding microstructure;
wherein the light-guiding plate includes a light-guiding body, a plurality of reflective microparticles disposed inside the light-guiding body, and a plurality of carrier substances disposed inside the light-guiding body to carry the reflective microparticles to be uniformly diffused inside the light-guiding body, wherein the refractive of the light-guiding body is different from the index refractive index of the reflective microparticle, the viscosity of the carrier substance is smaller than the viscosity of the light-guiding body, and the flowability of the reflective microparticles inside the light-guiding body is increased through the carrier substances.
